(19) United States
(12) Patent Application Publication
(10) Pub. No.: US 2024/0390840 A1
(43) Pub. Date: Nov. 28, 2024

(54) Method and Related Systems for Capturing Carbon Dioxide from Air

(71) Applicant: MEAGLOW LTD., Thunder Bay (CA)

(72) Inventor: Kenneth Scott Alexander Butcher, Thunder Bay (CA)

(21) Appl. No.: 18/670,015

(22) Filed: May 21, 2024

Related U.S. Application Data
(60) Provisional application No. 63/503,788, filed on May 23, 2023.

(51) Int. Cl. B01D 53/18; C05F 17/10; C05F 17/979

(52) U.S. Cl. CPC B01D 53/18; C05F 17/15; C05F 17/979

(57) ABSTRACT

A system and method for capturing CO2 from air includes exposing the air to a source of water such that CO2 in the water is below equilibrium with CO2 in the air. The water may be enriched with hydroxides. In a preferred embodiment, the CO2 may be captured along with ammonia that is released from decomposing biomass using an apparatus including a first chamber receiving the water and a second chamber receiving the decomposing biomass. The first and second chambers are connected to allow transmission of air between the chambers while collectively defining an enclosed space from which air cannot escape. As the biomass decomposes, the enclosed air is enriched with CO2 and ammonia such that the CO2 in the water is below equilibrium with CO2 in the air so the water absorbs some of the CO2 in the air within the enclosed space.

This application claims the benefit under 35 U.S.C. 119 (e) of U.S. provisional application Ser. No. 63/503,788, filed May 23, 2023.

### FIELD OF THE INVENTION

The present invention relates to a system for capturing carbon dioxide from air. More particularly, the present invention relates to use of water enriched with hydroxides from various sources prior to exposing the water to the air, and/or the use of an enclosed vessel containing decomposing biomass therein to increase carbon dioxide concentration in the air within the vessel that is exposed to the water.

### BACKGROUND

The International Panel on Climate Change has recognised in its 6th Assessment Report mention that green house gas (GHG) reduction will be insufficient to limit global warming to the international goal of 1.5° C. by 2100. Active means of carbon dioxide removal (CDR) will be needed with carbon capture and storage (CCS). As stated on page 24 of their third working group report: “All global modelled pathways that limit warming to 1.5° C. (>50%) with no or limited overshoot, and those that limit warming to 2° C. (>67%), involve rapid and deep and in most cases immediate GHG emission reductions in all sectors. Modelled mitigation strategies to achieve these reductions include transitioning from fossil fuels without CCS to very low- or zero-carbon energy sources, such as renewables or fossil fuels with CCS, demand side measures and improving efficiency, reducing non-CO2 emissions, and deploying carbon dioxide removal (CDR) methods to counterbalance residual GHG emissions.”

The need for CDR techniques has in fact been recognised for some time. In 2007 Richard Branson launched his Virgin Earth Challenge, which offered a $25 million prize to anyone, or any group, who could develop a technique for CO2 absorption that could remove and store large amounts of CO2. Over a 12 year period no entries satisfied the criteria to win the prize. One of the main obstacles being that “The system for removal of GHGs must be commercially viable.” However, the reality has been that without governments creating climate policies, and placing a cost on carbon production, there are very few economically viable business cases for CDR technology, and the few that can be made are only very small in volume in terms of CO2 sequestered. More recently Elon Musk has offered another carbon removal prize, this one worth $100 million, it is currently ongoing.

Some examples of possibly profitable CO2 removal businesses include CDR in spacecraft and submarines; rebreathers used for scuba diving; and ventilators used in hospitals. None of these examples utilises or sequesters large amounts of CO2. Another problem they face, and a reason many of these possibilities would not have qualified for the Virgin Earth Challenge, was that CDR solutions must be carbon negative. That is, the carbon produced in using the solution must be less than the carbon that is captured. The power used to enable the solution, the power used to create parts, and the power used to produce consumables must be considered when calculating this.

Many technologies proposed for CDR around the time of the Virgin Earth Challenge failed, not because of a lack of innovation, or inability to capture CO2, but because of poor economics. There are many successful but abandoned patents from that era. The problem being that many of those patents targeted industrial plants that produced large amounts of CO2 in high concentration, for instance coal based power plants, however, though many of the processes were well conceived there was no economic reason for these techniques to be adopted. There was no cost savings in adoption to offset capital costs involved. This is the basic problem for all current large-scale CDR techniques, only the more recent implementation of carbon taxes and CO2 emissions regulations has made some of these abandoned technologies now viable.

### SUMMARY OF THE INVENTION

Rather than appealing to large companies that find adoption unprofitable, and government bodies that make legislative address that allow CDR technologies to be artificially cost viable, the present invention seeks to provide solutions to environmentally concerned individuals with products that can empower them to make their own efforts to reduce CO2. In one instance described below, there does appear to be a viable economic reason for adoption of one of the techniques—for the local production of carbon and nitrogen fertilizers. Here we describe equipment and methods that are carbon negative and can achieve CDR with CCS at the individual and community levels.

According to one aspect of the present invention there is provided a capturing apparatus for capturing carbon dioxide and/or ammonia released from a decomposing biomass material, the apparatus comprising:
a first chamber arranged to contain water therein; and
a second chamber arranged to receive the biomass therein;
the first chamber and the second chamber being in open communication with one another such that gas and air can be transmitted between the first chamber and the second chamber; and
the first chamber and the second chamber collectively defining an enclosed space from which the gas and the air cannot escape.

Preferably an outlet valve is in communication with a bottom of the first chamber so as to be arranged to controllably discharge the water from the first chamber therethrough while the gas and the air remains trapped within the enclosed space.

The apparatus may further include an inlet valve in communication with the first chamber of the vessel at a location spaced above the outlet valve so as to be arranged to controllably introduce the water into the first chamber therethrough while the air remains trapped within the enclosed space.

In one embodiment, the first chamber and the second chamber are located within a common vessel and are separated from one another by a partition. The partition may comprise a screened member supported at a location spaced above a bottom of the vessel to define the first chamber below the partition and the second chamber above the partition, the partition being arranged to support the biomass material thereon while permitting the air to communicate through the screened member between the first and second chambers. Alternatively, the partition may be upright such that the first chamber and the second chamber are beside one another and communicate with one another across a top end of the vessel.

In a further embodiment, the first chamber and the second chamber may be located within a first vessel and a second vessel respectively. In this instance, the apparatus may include piping in communication between the first vessel and the second vessel through which the gas and the air can be transmitted between the first chamber and the second chamber.

Preferably at least the second chamber includes (i) a lid operable between open and closed positions relative to an opening in the second chamber through which the biomass material can be loaded into the second chamber, and (ii) a lock arranged to selectively secure the lid in the closed position to prevent opening of the lid by unauthorized persons.

Preferably, the water in the first chamber is enriched with hydroxides.

An air pump may be used to recirculate the air within the enclosed space between the first and second chambers.

A temperature sensor may be arranged to measure a temperature value representative of a temperature of the biomass material in the second chamber of the enclosed space.

A carbon dioxide sensor may be arranged to measure a carbon dioxide value representative of a carbon dioxide concentration level within the enclosed space.

A water conductivity sensor may be arranged to measure a conductivity value representative of an electrical conductivity of the water in the first chamber of the enclosed space.

A controller may be arranged to (i) monitor the value measure by any one of the sensors, (ii) compare the monitored value to a threshold range, and (iii) generate an alert responsive to the monitored value falling within the threshold range.

According to a second aspect of the present invention there is provided a method of capturing carbon dioxide and/or ammonia from biomass material, the method comprising:
providing a capturing apparatus comprising a first chamber and a second chamber in open communication with one another such that air can be transmitted between the first chamber and the second chamber, wherein the first chamber and the second chamber collectively define an enclosed space from which said air cannot escape;
placing the biomass material in the second chamber and allowing the biomass material to decompose in the second chamber whereby said air within the enclosed space is enriched with carbon dioxide and ammonia;
providing a source of water enriched with hydroxides in the first chamber such that carbon dioxide in solution in the water is below equilibrium with carbon dioxide in the air within the enclosed space and the water absorbs some of the carbon dioxide in the air.

The method may further include, after the water absorbs some of the carbon dioxide in the air, discharging the water from the enclosed vessel as fertilizer onto a plant growing medium.

The biomass material may include grass clippings from a lawn, garden waste, crop residue, manure, and/or other waste vegetation.

The method may further include adding microbes to the biomass material to enhance decomposition of the biomass.

According to another aspect of the present invention there is provided a method of capturing carbon dioxide from air containing carbon dioxide, the method comprising:
providing a source of water enriched with hydroxides such that carbon dioxide in solution in the water is below equilibrium with the carbon dioxide in the air;
and exposing the water to the air such that the water absorbs some of the carbon dioxide in the air.

Preferably the hydroxides with which the water is enriched consist primarily of calcium hydroxide.

The method may further include adding sugar to the water with the calcium hydroxide.

The method may further include deriving the calcium hydroxide from spoilt cement, waste concrete that has been ground into a granular form, and/or waste products of a smelting process.

The method may further include placing the calcium hydroxide in a filter bag within the water in which the filter bag only allows water soluble material to pass through externally of the filter bag.

The method may further include the hydroxides with which the water is enriched consist primarily of ammonium hydroxide derived from agricultural sources.

The hydroxides with which the water is enriched may further include sodium hydroxide.

In some embodiments, the method may further include exposing the water to the air by spraying the water into the air in the atmosphere from an elevated structure.

In this instance, a pH level of the water is preferably maintained below 9.5 before spraying the water into the air.

The method may further include minimizing evaporation of the water sprayed into the air by spraying the water into the air only when a temperature of the air is below a prescribed temperature threshold, and/or by spraying the water into the air primarily at night.

The method may further include spraying the water into the air in the atmosphere from the elevated structure at an elevation of 10, 20, 30, 40, 50, 60, 70, 80, 90, 100, 150, 200, 250, 300, 350, 400, 450 or 500 meters above surrounding ground level.

In further embodiments, the method may further include exposing the water to the air by bubbling the air upwardly through the water. In this instance, a pH level of the water is preferably maintained below 12.5 before bubbling the air upwardly through the water. The method may further include bubbling the air upwardly through the water by pumping the air into an air diffuser submerged within the water.

The method may further include exposing the water to the air by placing the water and the air within an enclosed space together with a decomposing biomass material within the enclosed space.

According to another aspect of the present invention there is provided a carbon dioxide capturing apparatus for capturing carbon dioxide from air, the apparatus comprising:
a vessel containing water enriched with hydroxides such that carbon dioxide in solution in the water is below equilibrium with the carbon dioxide in the air;
an air diffuser submerged within the water; and
a pump arranged to pump the air through the air diffuser such that the air is bubbled up through the water from the air diffuser.

Optionally, a filter bag containing cement products therein is submerged within the water to enrich the water with calcium hydroxide among said hydroxides, in which the filter bag is arranged to only allow water soluble material to pass through externally of the filter bag.

### BRIEF DESCRIPTION OF THE DRAWINGS

Some embodiments of the invention will now be described in conjunction with the accompanying drawings in which:

FIG. 1 illustrates an example system for capturing carbon dioxide from air according to a first embodiment of the present invention, utilising a tower and generating a spray of water into the atmosphere;

FIG. 2 illustrates another example system for capturing carbon dioxide from air according to a second embodiment of the present invention, utilising an existing building from which a spray of water is discharged into the atmosphere;

FIG. 3 is a schematic representation of an experimental system set up for capturing carbon dioxide from air according to a third embodiment of the present invention, in which air is bubbled upwardly through water;

FIG. 4 is a graphical representation of carbon dioxide concentration reduction measurements when bubbling air through tap water according to the third embodiment;

FIG. 5 is a schematic representation of an example system for capturing carbon dioxide from air according to a fourth embodiment of the present invention, in which air is bubbled upwardly through an aqueous solution treated with waste concrete;

FIG. 6 is a graphical representation of normalized carbon dioxide reduction seen for air bubbling through tap water according to the fourth embodiment, using different pH additives;

FIG. 7 is a schematic representation of an example system for capturing carbon dioxide from air according to a fifth embodiment of the present invention, in which air is enclosed within a closed vessel including a decomposing biomass therein that releases carbon dioxide into the air within the vessel;

FIG. 8 is a graphical representation of carbon dioxide emissions from grass clippings within a closed vessel according to the fifth embodiment;

FIG. 9 is a graphical representation of carbon dioxide concentration within the closed vessel reaching a steady state over time as carbon dioxide is both emitted by the grass clipping and absorbed in the water enriched with hydroxides from waste cement; and

FIGS. 10 and 11 are schematic representations of further variants of the embodiment of FIG. 7, in which a decomposing biomass releases carbon dioxide and ammonia into the air within an enclosed space that also includes a volume of water contained therein to absorb some of the carbon dioxide and/or ammonia in solution within the water.

In the drawings like characters of reference indicate corresponding parts in the different figures.

### DETAILED DESCRIPTION

There are two basic ways through which the Earth itself reduces CO2. These are the short and long carbon cycles. The short carbon cycle involves absorption of CO2 by plant life. This is regarded as the short cycle because the carbon stored in trees, plants and grasses is re-emitted once that vegetation dies with a great deal of it eventually returning to the atmosphere. Grass stores for a short period of time, plants for longer, and trees for decades. Canada's vast forests have in the past been a carbon sink, since they have absorbed more carbon than they released, however in recent years forest fires, insect infestation outbreaks, and deforestation have resulted in Canada's forests being a carbon source so that substantial replanting is required to offset this, or the application of other means of CDR.

Interestingly, with global heating NASA has found that the Eastern United States has become a greater carbon sink in recent years, as increased rainfall there has resulted in the growth of more vegetation. Water is apparently required for increased CO2 uptake, which makes sense since many plants are about 50% water and 50% CO2. Also, rain helps to remove CO2 from the atmosphere, since water absorbs CO2 as carbonic acid, or dissolved CO2. In fact, with the historically high CO2 levels in the air (currently ˜400 ppm) all rain is slightly acidic with a pH of about 5.6 because of the presence of carbonic acid.

The observations of enhanced plant growth with water and CO2 is referred to as carbon fertilization. It was noted in the 1920s that plants absorb CO2 as carbonic acid from the air. Some cannabis growers are actively adding CO2 gas to their greenhouses to enhance carbon fertilization, however the need for water makes this method inefficient, delivery of carbon species already dissolved in water makes better sense.

In terms of the carbon fertilization seen in the Eastern United States, carbonic acid probably plays a strong role. Carbonic acid is generated in rainwater via the chemical reaction:

$${CO}_{2 ( aq )} + {H}_{2} O \to {H}_{2} {CO}_{3} \qquad [ 1 ]$$

Dependent on the pH of the water, at higher pH the reaction paths change and the carbonic acid loses hydrogen ions.

The long carbon cycle, sometimes called the carbonate-silicate cycle, also involves rain with carbonic acid from the atmosphere. This slightly acidic rain erodes silicate and carbonate based rocks, for instance Wollastonite (CaSiO3) erodes through the chemical reaction:

$${CaSiO}_{3} + 2 {H}_{2} {CO}_{3} \to {H}_{2} {SiO}_{3} + 2 {HCO}_{3}^{-} + {Ca}^{2 +} \qquad [ 2 ]$$

The eroded products of this reaction will often make it to the sea where a process called carbonate precipitation can occur, via the reaction

$$2 {HCO}_{3}^{-} + {Ca}^{2 +} \to {CO}_{2} + {CaCO}_{3} + {H}_{2} O \qquad [ 3 ]$$

For this final reaction one carbon dioxide molecule is released, however two carbon dioxide molecules are used for the two reactions together so that there is a net storage of carbon dioxide. The final product, CaCO3, is stored as limestone at the bottom of the ocean, sometimes for millions of years.

Direct absorption of CO2 by the ocean also occurs and results in CaCO3 storage via these reactions

$${CO}_{2 ( g )} \to {CO}_{2 ( aq )} + {H}_{2} O \to {H}_{2} {CO}_{3} \to {HCO}_{3}^{-} + {H}^{+} \to {CO}_{3}^{2 -} + 2 {H}^{+} \qquad [ 4 ]$$

$${Ca}^{2 +} + {CO}_{3}^{2 -} \to {CaCO}_{3} \qquad [ 5 ]$$

CO2 gas is first absorbed in the sea water as an aqueous gas, then eventually becomes carbonic acid, but as the ocean is slightly alkaline, both hydrogen ions are lost. The remaining carbonate combines with calcium ions in the ocean. Though in this case the source of the calcium ions can be a concern. If it is from calcium hydroxide already dissolved in the ocean that is not problematic (except that less calcium may be available to some sea life for shell building), however the acidic hydrogen ions released from carbonic acid can dissolve existing calcium carbonate so that there is no net gain, and ocean acidification occurs.

When considering methods of absorbing CO2 using water spray and misting, as rainwater absorbs CO2 it is noted that the reaction between CO2 and water by itself is slow, and that many terrestrial water sources are already in equilibrium with CO2 so that they can't absorb any more. This may not be true of treated tap water, or some water sources that have been in contact with alkaline materials, such as ammonia runoff from farms. Alkalinity also actually helps increase the speed of CO2 uptake, this is true of both ammonia and hydroxides. We look at some methods and equipment for CO2 reduction using water spraying.

For some of the methods and equipment described here we also emulate the long carbon cycle of nature by producing CaCO3 as a final product for sequestering CO2. The 2004 review by Zeman and Lackner (World Source Review, volume 16, no. 2, pgs 157-172 in print only) provides an overview of some of that early work from 1946 onward, from that review: “In the bulk fluid, dissolved CO2 reacts with water, or hydroxide ions to form carbonate or bicarbonate ions. In contrast to the reactions of CO2 with water, the reactions with hydroxide reactions are very fast and their reaction time can be ignored (Astarita, 1967).”

With regard to the use of hydroxides in an aqueous solution for capturing carbon dioxide from air, it is noted that sodium hydroxide can be dangerously caustic. Also, it's use in household applications is being limited by governments because of the potential for it to be used in illicit drug manufacture. Since we are looking to enable equipment and methods that can be used by ordinary people, we wish to avoid the use of sodium hydroxide. Calcium hydroxide by itself is much safer to use as its solubility in water is limited to 1.73 grams/Litre at 20 degrees Celsius, and therefore the highest pH it can reach is limited by this to a value of 12.3 at that temperature. Values above 12.5 are regarded as harmful, so that calcium hydroxide is relatively safe compared to sodium hydroxide. It is commonly used for the treatment of swimming pools because of its self-limiting pH property. Also, once the hydroxide ion has been consumed in the formation of a carbonate, the carbonate precipitates out of solution, allowing another calcium hydroxide molecule in solid form to become aqueous and replace the used hydroxide in solution, so there can be a reservoir of solid calcium hydroxide available for conversion into dissolved solution. This means that the overall volume of water needed for capturing CO₂ can be reduced.

Again, one of the other issues with producing CaCO3 as the final product of a CDR process is that the raw materials used often use more CO2 to produce than can be sequestered. We have been looking at the use of waste concrete and cement products to offset this. Approximately 5% of human CO2 production comes from cement production, however many of the waste products, eg. spoilt cement and old concrete, can be used to re-absorb CO2, and because these products are being recycled instead of wasted, there is a reduced carbon deficit in their supply. However, this is not a new idea either. Government pressure and incentives have created major efforts to reduce CO2 produced during cement manufacture, most effort being directed to outputting less CO2 during the actual production.

Generally, the present invention relates to a carbon capturing system for performing a method capturing carbon dioxide from air by various means. The methods described herein generally include providing a source of water enriched with hydroxides such that carbon dioxide in solution in the water is below equilibrium with the carbon dioxide in the air, and exposing the water to the air such that the water absorbs some of the carbon dioxide in the air. In preferred embodiments the hydroxides with which the water is enriched consist primarily of calcium hydroxide, which may be derived from spoilt cement. ground waste concrete, or as a waste product from a smelting process for example. In the instance of spoilt cement, sugar may be added to the water with the calcium hydroxide to prevent partially set cement from fully setting. Preferably the calcium hydroxide is placed in a filter bag that is submerged within the water in which the filter bag only allows water soluble material to pass through externally of the filter bag. Alternatively, in a further embodiment, the hydroxides with which the water is enriched may consist primarily of ammonium hydroxide when the hydroxides are derived from agricultural sources, such as agricultural run-off. Sodium hydroxide may be added to any of the other hydroxides noted above to improve effectiveness of carbon capture.

We define spoilt cement for the purposes of this application as cement that has come in contact with some moisture so that it is partially set. Such cement is often deemed unsuitable for purpose and is disposed of, often with no opportunity for further CO2 uptake by the unspoilt fraction. We define concrete as cement that has been properly set for construction purposes.

The advantage of using cement and concrete waste is that there is significant amounts of CaO and Ca(OH)2 in cement, as well as other oxides and hydroxides, and lesser amounts of the same in concrete waste. CaO will also react readily with water to form further Ca(OH)2. So there can be substantial amounts of calcium and other hydroxides that can be used to form carbonates from CO2. This waste can include crushed concrete, which will have a proportion of oxides and hydroxides still available. It can also include spoilt (moisture affected) cement that may have substantial amounts of unreacted oxides and hydroxides available.

In another embodiment discussed below, we have found that there is an excellent route for harvesting CO2 and NH3 from grass clippings and producing liquid fertilizers that can be reapplied to local gardens, green houses or farm sites. This technique relies on the fast carbon cycle but extends the ability to store the carbon that is rapidly absorbed by grass and then usually rapidly returned to the atmosphere. It is widely held at the moment that the best way to treat grass clippings, is to leave them on the lawn where some CO2, NH3 and other decomposition products can be returned to the soil, however this really only occurs if there is substantial water added to the clippings, either from rain, or from artificial irrigation (which is wasteful in terms of CO2 since water treatment and pumping produce CO2). Otherwise, these volatile components largely evaporate and are returned to the atmosphere. By collecting these products in water solutions they can be reapplied to vegetation and soil without the need for other wasteful processes, enabling a longer storage period. Carbon and nitrogen based fertilizers can therefore be harvested locally, even at the household level reducing the need for commercial fertilizers, this provides an economically viable impetus for CO2 capture.

In fact, the water supplied for this application could be tap water, which is chemically treated. However, as mentioned above, one of the things we realised with the use of tap water for gettering CO2 is that it's very possible that the tap water is already in equilibrium with CO2 in the atmosphere. In that case it would be ineffective for gettering CO2 at the level its in equilibrium with. However, in some cases water treatment could actually lower the CO2 content of the tap water, in which case it could absorb more.

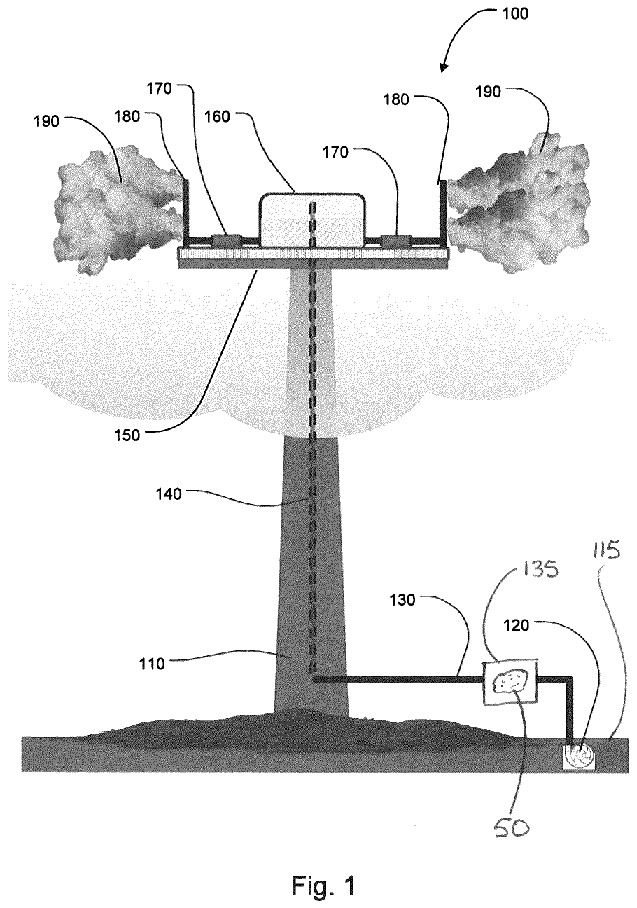

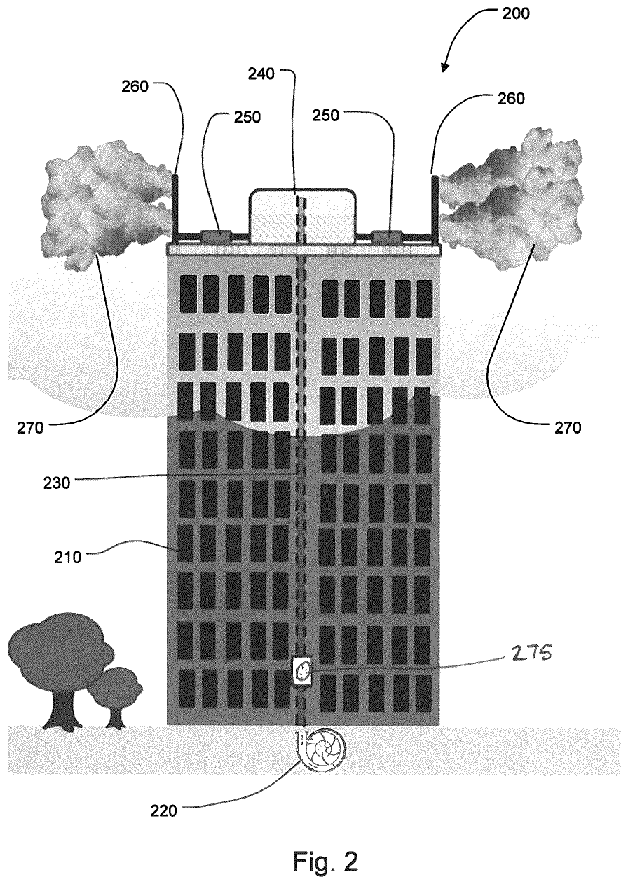

According to the embodiments of FIGS. 1 and 2, water is enriched with hydroxides such that carbon dioxide in solution in the water is below equilibrium with the carbon dioxide in the air, and then sprayed into the atmosphere from an elevated location. One thing to watch with spraying water is the effects of evaporation. Using a handheld CO2 monitor (Temtop M2000) we noted that for normal rainfall, when there was significant evaporation of water this caused a release of CO2 from the evaporated water that resulted in a rise of the local CO2 value. For instance, on the 11 Nov. 2021 in Thunder Bay, Ontario, there was a rain storm mixed with significant sunny periods. The temperature was 7 degrees Celsius, the humidity with the rain was very high at 90% (as given by the meter) which was related to the high rate of evaporation, and the CO2 level was measured as being 540 ppm, whereas the normal value is about 400 ppm, so a significant amount of CO2 was being released from the evaporated rain. For normal rain, a large percentage of CO2 is still removed from the atmosphere despite a small proportion of the water evaporating. For tap or treated water, unless a reasonable proportion of the CO2 has been removed from the water ahead of spraying into the atmosphere, the evaporated water spray can be a significant source of CO2 emission. Therefore, for water spraying to be successful in reducing CO2 levels from direct spraying effects (and this ignores the benefits of carbon fertilization) the water needs to be depleted of CO2 enough to overcome any deficit related to water evaporation during spraying. For rain at night, we've observed that evaporation affects can be negligible. Night time spraying is therefore preferable. For snow fall in winter, similarly, evaporation effects can be negligible. Snow can also getter CO2 from the atmosphere. We found that during the snow storm of 24 Dec. 2022 in Thunder Bay, that the outside CO2 level was 360 ppm, 40 ppm below the usual level. The calibration of the CO2 monitor was checked outside 5 days later and was measuring 401 ppm, which is the usual value so that the monitor zero had not drifted.

A number of experiments (24 Jan. 2022) were carried out with sprayed water in an enclosed 72 Litre container using our CO2 monitor to measure any reductions in the CO2 level. The meter was shielded from the spray with a gas permeable cloth. We used a dry fog spray nozzle that produced very small droplets less than 10 micrometers in diameter, which do not wet people, but evaporate on contact. This type of spray is probably not what should be used for a tall tower as it would cause too much evaporation, but water droplets need a period of time to equilibrate with CO2 and larger droplets can equilibrate from a tower in an appropriate period of time because of the longer time the droplets spend in the air, for this testing smaller droplets were needed because they could equilibrate more quickly in the smaller test volume. To do the so called “dry fog”, an air supply has to be mixed with the water supply. The water supply was tap water in the 72 Litre container. The air was supplied by a compressor. Prior to spraying, air was bled into the container from the compressor so that the CO2 level was the same as the air supplied by the compressor. The start value was 913 ppm (inside CO2 levels tend to be higher than the 400 ppm usually seen outside). Four 10 second water sprays were undertaken about 7 minutes apart, each resulted in a drop of the CO2 level to an eventual value of 844 ppm, despite the compressed air supplying a higher value. The pH of the tap water was 8.8 and was higher than that of rain water since tap water can be treated with alkaline chemicals such as Ca(OH)2, the treated water therefore has an ability to absorb CO2. In this experiment, because it was a closed system, evaporation had no effect.

Adding waste cement to a water mixture raises the pH of the solution, using crushed concrete we observed an increase in pH up to 9.4 for one experiment. Alkaline water of pH 9.5 is sold for physical consumption, so the pH is relatively safe at this level. Raising the pH above that of rain water, by addition of hydroxides or ammonia will allow absorption of further CO2 by the water. Treated tap water is actually quite wasteful for water spraying, the treatment process uses a lot of CO2 through the use of chemicals that produce CO2 during their manufacture; and through the use of pumps and other equipment that require power and hence produce CO2 from that. Untreated water sources from rivers, creeks, lakes or other sources of rainwater are a better option. An invention embodiment would be to run this water through a bed of crushed concrete prior to spraying. This would provide hydroxides that can react with carbonic acid already in the water to form carbonates that precipitate to remove CO2, thus allowing more CO2 to be absorbed by the water. The hydroxides can also increase CO2 uptake by increasing the pH. Another possible embodiment is to use crushed concrete in the bed of decorative fountains, so that those can serve the useful purpose of CO2 absorption and subsequent conversion to carbonates rather than just look pretty.

A third embodiment is to use water from near a farm or other rural setting where substantial ammonia is in the water. Ammonia (NH3) will form ammonium hydroxide (NH4OH) in water, via the reactions

$${NH}_{3 ( g )} \to {NH}_{3 ( aq )} \qquad [ 6 ]$$

$${NH}_{3 ( aq )} + H 2 {O}_{( l )} \to {NH}_{4} {OH}_{( aq )} \to {NH}_{4 ( aq )}^{+} + {OH}_{( aq )}^{-} \qquad [ 7 ]$$

which are reversible at higher temperatures resulting in ammonia evaporation. The free hydroxides of these reactions raise the water pH and can be used for CO2 capture. CDR using ammonia has been known for some time, see for instance the review at International Journal of Greenhouse Gas Control 2 (2008) 9-20, and is being actively pursued. Though apparently there can be many reaction paths in a system open to the environment, the dominant one should be related to the production of ammonium bicarbonate through the reaction between ammonium hydroxide and carbonic acid, i.e.

$${NH}_{4} OH + {H}_{2} {CO}_{3} \to {NH}_{4} {HCO}_{3} + {H}_{2} O \qquad [ 8 ]$$

Ammonium bicarbonate is apparently used as an inexpensive nitrogen fertilizer in China. This compound in fact can also provide carbon fertilization, so it serves a dual purpose. Spraying of a dilute mixture of ammonium hydroxide compound in conditions that limit evaporation (at night, late evening and early morning) could be beneficial for fertilization of forests and/or crops.

Turning now more particularly to FIG. 1, an embodiment of a system 100 for capturing carbon dioxide from the atmosphere is illustrated which shows a tower 110. The tower 110 is located with access to a source of water 115 such as a river, lake or dam, or a municipal water supply, and the water is moved by a pump 120 to the tower 110 via a pipe 130, which can be one or more pipes. The water passes through a treatment chamber 135 in line with the pipe 130 so that the water passes through the treatment chamber, in which the treatment chamber provides a source of hydroxides such as calcium hydroxide and other hydroxides derived from spoilt cement or waste concrete optionally contained within a filter bag 50 as described above.

Alternatively, rather than treating the water by use of a treatment chamber 135, the source of water 115 may already be enriched with hydroxides, for example by use of a source of water that includes agricultural run-off so that the hydroxides in the water consist primarily of ammonium hydroxide.

Once the water reaches the tower 110, the water is transferred to a service platform 150 using a tower pipe 140, which can be one or more pipes located inside or outside the tower 110. Located on the service platform 150 is a water storage tank 160 for providing a localised source of water for the tower 110. The water tank 160 may be used as a treatment chamber instead of or in addition to the treatment chamber 135 by locating an additional source of hydroxides like spoilt cement or waste concrete optionally contained within a filter bag 50 within the tank 160.

From the water storage tank 160 the water is sent, using one or more pumps such as tower pumps 170, to one or more water spray nozzles via a water feed device 180, such as a pipe. Use of the water storage tank 160 and the tower pumps 170 allow the system 100 to operate with a degree of independence from the water supplied by the pump 120. The tower pumps 170 also allow the one or more water spray nozzles to operate at a different pressure than the water from the pump 120. The one or more water spray nozzles generally face away from the tower 110 to send out a spray of water 190, i.e. a mist of water. The spray of water 190 may then evaporate to increase an amount of moisture in the atmosphere around the tower 110. The increased moisture together with the hydroxides in the water react with the carbon dioxide in the air to produce precipitation which returns carbon dioxide to the ground in the form of various carbon sequestering compounds as described above.

The tower 110 may be of varying height above the ground. For example, the tower 110 may have a height of about 10, 20, 30, 40, 50, 60, 70, 80, 90, 100, 150, 200, 250, 300, 350, 400, 450 or 500 meters above surrounding ground level. As the height of the tower increases, the spray of water 190 is produced higher above the ground and may be distributed over a larger area. In addition to using the height of the tower, the overall elevation of the spray of water 190 may be increased by taking advantage of naturally occurring geography, such as building the tower on top of a hill. In certain circumstances, the platform 150 may be elevated on a hill without additional elevation from a tower structure.

While the system 100 is shown with the water storage tank 160, water may be pumped directly to the nozzles. Removing the water storage tank 160 will reduce weight on the service platform 150 but may require additional pumps or a modification to the pump 120, such as increasing output water pressure. The nozzles may be configured in a number of different arrangements. In one embodiment, the nozzles are located around an edge of the service platform 150 in a square, rectangular or circular shape. Operation of the nozzles may be individually controlled or controlled in groups. Control of the nozzles or nozzle groups may be performed by one or more microprocessors, such as a PC or other form of computer. Controlling nozzle operation allows the system 100 to release the spray of water 190 according to wind direction and prevent the spray of water 190 from being blown back on to the system 100 by selectively not using any of the nozzles operating upwind. Alternatively, the nozzles may be configured on a rotating platform that rotates with wind direction, in a similar manner to wind turbines. Such an arrangement allows that all nozzles are used but with additional complexity incurred by using a rotating platform. Alternatively, nozzles may be directed upwards or downwards to direct the spray of water 190 above or below the service platform 150. In some embodiments heating elements may be provided. For example, the nozzles may have a heating element located within or at a nozzle, such as a high frequency or radio frequency (RF) induction heater or a microwave heater.

The method of spraying water into the atmosphere according to FIG. 1 or 2 preferably includes maintaining a pH level of the water below 9.5 before spraying the water into the air. Also, the method may further include minimizing evaporation of the water sprayed into the air by spraying the water into the air only when a temperature of the air is below a prescribed temperature threshold. This may include spraying when the temperature is below freezing temperature so that the spray water or mist forms snow. Alternatively, the water may be sprayed into the air only or primarily at night.

An alternative system 200 is illustrated in FIG. 2. Preferably, system 200 is used with fresh water for fresh water precipitation production. Tall buildings or skyscrapers, such as building 210, may have an existing water pump 220 for pumping water via pipe 230, or one or more pipes, to an existing water storage tank 240 located on or near the top of the building 210, such as on a roof or near the roof. Typically the water for the water storage tank 240 is supplied from a town water system and the water is pumped to the water storage tank 240 to provide water for occupants of the building 210. The water level of the water storage tank 210 is monitored and replenished using pump 220 as required.

Pumps, such as building pumps 250 located on the roof of building 210, provide pressure for delivery of water to nozzles via a water feed device 260 to produce spray of water 270. The nozzles are located about an edge of the building 210 and spray water away from the building 210. Operation of the nozzles may be controlled in a manner similar to the system 100 of FIG. 1, described above, in relation to varying nozzles depending on a wind direction. Typically, tall buildings are grouped together, so the nozzles may also take into consideration a wind direction and a location of surrounding buildings. For example, if a tall building is located nearby and downwind to building 210, then the nozzles may stop operating until a change of wind direction directs the spray of water 270 away from the nearby building.

According to the second embodiment of FIG. 2, the water is again pumped through a treatment chamber 275, in which the treatment chamber again provides a source of hydroxides such as calcium hydroxide and other hydroxides derived from spoilt cement or waste concrete contained within a filter bag 50 as described above. Alternatively, the tank 240 may be used as a treatment chamber for providing a source of hydroxides instead of or in addition to the treatment chamber 275.

In addition to being installed on the building 210, the system 200 may also be installed on other buildings, located nearby, to form a group of fresh water spray systems. In such a grouping, the number of nozzles available will be increased, as well as increasing an area over which water can be evaporated. The operation of each fresh water spray system may be co-ordinated to provide better outcomes for the overall system. For example, nozzles located upwind may have an amount of water spray reduced or stopped, while nozzles located downwind may be in full operation. Spray delivery may also be co-ordinated with air quality measurement stations located in the city with regions of high air pollution receiving higher volumes of water spray to coagulate with the air pollution. Alternatively, or additionally, a size of droplets of the water spray may be adjusted across the city based on the air pollution readings to match the detected air pollution type and increase coagulation of the water and pollution.

The system according to FIGS. 1 and 2 as described herein is suitable for inducing precipitation in an atmosphere to control air pollution, such as may occur in a manufacturing environment. For example, nozzles may be mounted on a chimney stack. The chimney stack may be the source of the pollution. Alternatively, the system may be mounted to other structures located near the source of pollution. However, when water droplets combine with some pollutants the combination may be damaging to the environment. For example, hydrogen sulphide may convert to sulphur dioxide in the atmosphere. When sulphur dioxide combines with water, the result is sulphuric acid which is a main component of acid rain. Acid rain is undesirable due to the negative effects on the natural and built environment. Similar undesirable results may occur when water droplets combine with nitrogen oxides and form nitric acid.

The water dispersed to reduce pollution may have anti-pollutant chemicals added to ameliorate problems caused by water combining with some pollutants. For example, calcium carbonate may be added to the water to produce a calcium carbonate saturated water mist. Such a mist may allow for safe, wind driven, removal of sulphur dioxide as the mist may combine to form PH neutral calcium sulphate. The mist would also work on nitrogen oxides to form calcium nitrate. The calcium carbonate saturated mist may be formed by pumping water into a chemical tank with a lime or limestone slurry and passed through a filter to remove any remaining solids. The water out of the filter contains dissolved calcium carbonate that may be pumped to a mist tower for dispersion with the wind, to combine with pollutants.

In some colder climates, water mist may turn to ice once the mist is in contact with the atmosphere. In such a situation, both water and heated air may be required in a two fluid spray nozzle. Water connections may be trace heated and water may be flushed from the water line, using air to minimise ice formation, at the end of operation of the spray nozzle. Such a system may have a winter and summer setting, and use a pressurized, heated air supply when the weather is cold. Alternatively, or in addition, de-icing chemicals may be added to the water. Although salt, NaCl, may not be able to de-ice to low temperatures such as −35 C, calcium chloride CaCl2 can. However, calcium chloride may affect some materials, such as concrete, over time. One implementation may use a blend of NaCl, CaCl2 and a water softener to alleviate the effects of CaCl2 on concrete.

When spraying water in the open, alkaline additives need to be limited in their pH to prevent environmental damage. A pH of 9.5 seems like a viable upper limit, but may depend on local soil alkalinity and may need local assessment. In contrast bubbling air through a local water source is another way of contacting large amounts of CO2 and in this case higher pH levels can be used to make CO2 collection more efficient since the system is fully contained with no chemicals being spread to the environment. For use by ordinary people it is probably still safer to limit the pH, and in this case we limit it to the pH of spoilt cement solution, which we have found to be in a maximum range of 11 to 13, with the dominant hydroxide Ca(OH)2 being at a pH of 12.3 at 20° C. when at high concentration, however lower levels of NaOH and KOH can also be present that raise the level above this, while the presence of sulphates may lower the pH. Ca(OH)2 itself is commonly used in the cooking industry as lime water, while cement is openly available at hardware stores, so there is a history of ordinary people dealing with materials of this level of alkalinity.

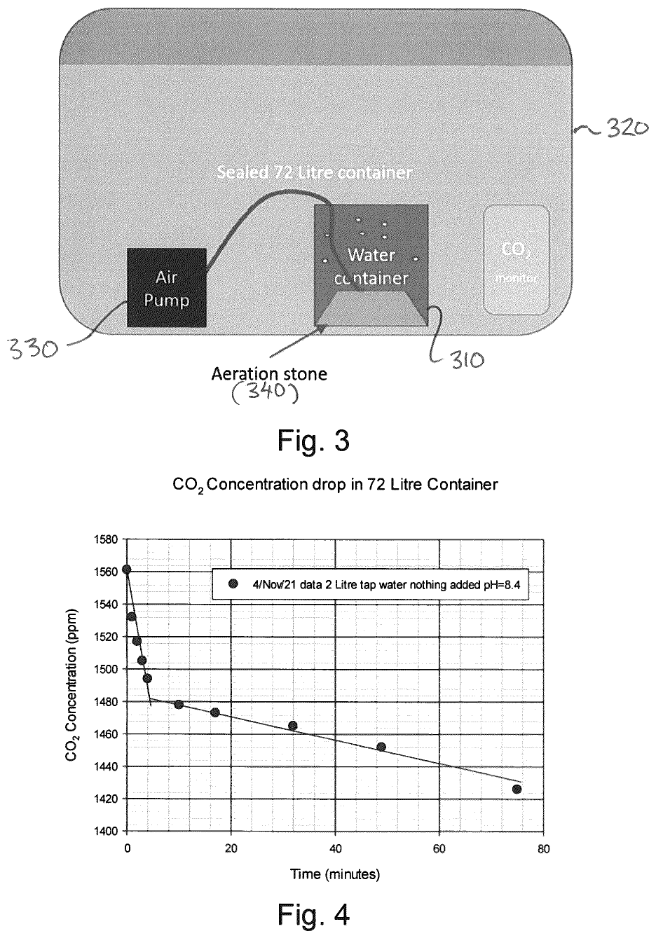

In another experiment (4 Nov. 2021) 2 Litres of tap water with pH=8.4 was placed within a water containing vessel 310 inside the 72 Litre container 320 with an aquarium air pump 330 connected to an aeration stone 340 that was in the water as shown in FIG. 3. The water in the vessel is in open communication at an open top of the vessel with the surrounding air within the container that was source from atmospheric air. Air was recirculated from the sealed container by the pump through the water. The aeration stone provided small bubbles so that the surface area of water to air was quite high.

As shown in the graph of FIG. 4, below, for this setup the starting CO2 level was 1561 ppm, and after 1 hour and 14 minutes the value fell to 1426 ppm. This experiment also shows that some absorption of CO2 can be obtained with treated tap water. Two different time constants of CO2 absorption are evident in the graph, as indicated by the two lines fit to the data. There is an initial rapid absorption of CO2, which is assumed to be primarily from calcium hydroxide, commonly used for water treatment, resulting in the simplified reaction,

$${Ca ( OH )}_{2} + {CO}_{2} \to {CaCO}_{3} + {H}_{2} O . \qquad [ 9 ]$$

However, at a pH of 8.7 all of the hydroxides would be consumed in the initial drop to 1482 ppm in fact a greater amount of CO2 is absorbed than can be accounted for by hydroxide absorption of CO2 in 2 Litres of water alone. As indicated in above equation [4], water can absorb CO2 directly in solution, via the equation

$${CO}_{2 ( gas )} \to {CO}_{2 ( aq )} + {H}_{2} O . \qquad [ 10 ]$$

It therefore seems that the relatively rapid uptake of this amount of CO2 was from the available hydroxide ions in the treated tap water and from CO2 aqueous absorption. The slower absorption below 1482 ppm is due to absorption of CO2 as carbonic acid, which is known to be a slower process. The start CO2 level was higher than the outdoor level (˜ 400 ppm of CO2 outside) so that further absorption of CO2 could occur even if the tap water was at equilibrium with that 400 ppm level of CO2. However, it is apparent that water with pH above rainwater has capacity to absorb CO2 even when the level is the same as the 400 ppm outside level. Treated water can therefore be used in some circumstances to absorb CO2.

The problem with bubbling air through only slightly alkaline water is that the pump energy produces CO2. The Vivosun pump used is an aquarium air pump, it has a 30 watt power usage and 60 L/min air output capacity. Over 24 hours the pump power uses 0.72 KW-hours of power, the province of Ontario generated 151.1 TW-hours of power in 2018 equivalent to 1.51×1011 kW-hours. In 2017 electricity generation in Ontario generated 2.0 MT of CO2=2×109 kg, which is low compared to other areas of the world as Ontario uses large amounts of hydroelectricity and nuclear power, which have low CO2 output. So in Ontario a 30 watt pump will create 9.5 grams/day of CO2. The initial fast CO2 reduction from the graph was for 80 ppm in 5 minutes=960 ppm/hour, which is the equivalent of 1.728 mg/L or in the 72 Litre container 0.124 grams/hour or 2.986 grams/day. So, in this case, even with the faster absorption part of the curve the CO2 sequestered is less than the CO2 produced by the pump. Greater absorption was needed and a more efficient pump.

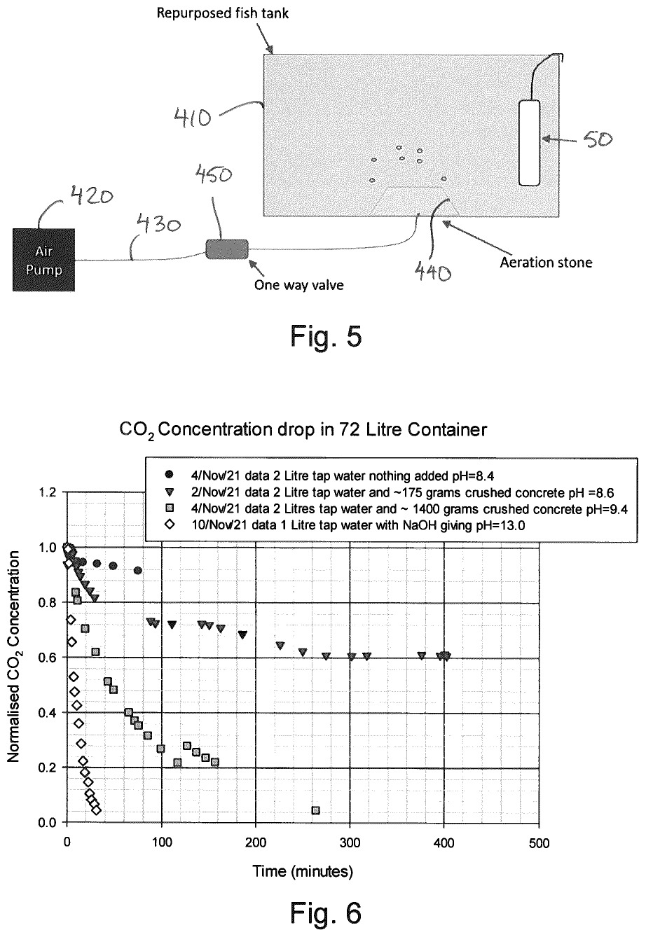

Turning now to a further embodiment according to FIG. 5, a water containing vessel 410 is provided, for example a repurposed fish tank, which contains water or an aqueous solution therein. Atmospheric air is pumped by an air pump 420 through a tube 430 connected to an air diffuser such as an aeration stone 440 that is submerged within the vessel 410. A one-way valve 450 is connected in series with the tube 430 to prevent backflow of water through the tube 430 when the air pump is not operating while permitting flow of air from the pump to the diffuser when the air pump is operating. Crushed waste concrete or spoilt cement is again provided as a source of calcium hydroxide within a filter bag 50 as described above.

Adding crushed concrete to the water raises the pH of the water allowing it to absorb CO2 more quickly. The graph in FIG. 6 shows the reduction in the normalized CO2 level in the 72 Litre container using the same conditions as the above experiment. The CO2 levels were normalised to their start value as the start value of the container was affected by operator breathing during the sealing procedure. In this case hand crushed concrete was used. The graph shows the same experiment as the above graph having tap water with no concrete added; a new experiment with ˜175 grams of crushed concrete added to water; water with ˜1400 grams of concrete added, and for comparison, water with high pH NaOH solution added. It can be seen that the absorption of CO2 improves greatly with increased pH.

In the best case with NaOH added, the CO2 removal rate (at 400 ppm) was 2.75 grams/day, again well below the 9.5 grams/day used by the 30 watt pump.

We moved to a lower flow pump, a Pawfly MC-3000 which used 7 watts of power for a much lower flow rate of 16 L/min. The advantage of this is that the Pawfly aeration stone used was made to operate best in a particular air flow range of 15 L/min, so this pump is closer to that. At the lower air flow smaller bubbles are produced. Smaller bubbles give a better surface area to the water enabling greater gas exchange. Doing this the equivalent CO2 produced by this pump was 2.21 grams/day.

In an experiment with the Pawfly pump the Pawfly aeration stone was placed in an ABS container with 1.5 Litres of water, 333 grams of crushed concrete and NaOH which brought the solution pH to 13.9. This was run in the 72 Litre container. At 400 ppm of CO2 the removal rate of CO2 was 40 ppm/minute or 7.57 gram/day. This removal rate is three times higher than the electricity used by the pump, this is because the lower flow of the pump provided smaller air bubbles, and because of the slightly higher column of water, which means that air bubbles were in contact with the water for a longer period. In this case the use of NaOH in a sealed container could be used, but only by trained staff. This is not optimal in terms of our ultimate aims, but it shows that carbon negative removal of CO2 can be achieved in terms of the power used.

This will change when the CO2 level is higher. At the moment the removal rates at 400 ppm are being given here because that is the average outdoor level. However, as discussed in section 6) below the efficiency of CO2 collection increases proportionally to the CO2 level, so if the CO2 level were 4000 ppm, the efficiency would be 10 times more. As discussed in section 6), using grass clippings to increase the CO2 level would make CO2 collection with crushed concrete (without NaOH) a carbon negative process.

The basic problem with using concrete waste on its own was getting the solution pH high enough to absorb CO2 efficiently enough for it to be a carbon negative process. The addition of NaOH was needed for this for a background level of 400 ppm, though at higher CO2 levels the process does become carbon negative. The dominant hydroxide from the crushed concrete was Ca(OH)2. A higher level of unreacted Ca(OH)2 is available from spoilt cement. Experiments were done using Portland cement that was partially set and therefore deemed to be unusable. The large chunks of partially set cement were crushed down by hand with a mortar and pestle and then sugar was added to 1 to 3 weight percent to prohibit the cement from setting. The sugar also improves the solubility of Ca(OH)2. The particular cement we were using could raise the pH of a solution to 11.5, this is the same value provided by Chang and Chen for a similar cement, Portland type I, we were using Portland type 10. Sodium sulphate additions and heat treatments can apparently lower the pH from that expected for Ca(OH)2.

For one experiment, using the Pawfly pump, and the Pawfly aeration stone at the bottom of the ABS container previously mentioned, 196 grams of the Portland cement were added to 1.5 Litres of tap water. 2 cubes of sugar were added to the mixture to stop the cement from setting (approx. 7 grams). At 400 ppm the CO2 was being reduced by 18.5 ppm/minute, equivalent to 3.50 grams/day of CO2 (2 Feb. 2022). Given the 2.21 grams/day used by the pump, this was a carbon negative experiment, however the amounts being described were quite small, especially given that a single person exhales 1000 grams/day of CO2. Scaling becomes the issue, using 6 Pawfly aeration stones with 28 Litres of water in a bigger container with Portland cement and sugar we were able to remove 22.7 grams/day of CO2 with the Vivosun pump (16 Feb. 2022), which produces 9.5 grams/day, so this experiment was also carbon negative and demonstrated the process was scalable, though the experiment bulk becomes problematic for large scale operation when only removing CO2 from an area with background levels of 400 ppm. Higher background levels would be useful, as described in a further embodiment below.

Despite the low CO2 reduction seen with these experiments, they do appear to be scalable and a product based on the technique can be envisaged, in particular, for one embodiment a fish aquarium can be repurposed to absorb CO2 by bubbling room air through an aeration stone using a low wattage air pump and thence through aquarium water saturated with spoilt cement products, in particular Ca(OH)2. The spoilt cement may have to be reground, though this can be done by hand to limit CO2 production. The spoilt cement can be placed in a filter bag made of material so that only soluble products make it out of the filter bag and so that end waste material can be easily removed. The spoilt cement would be mixed with a small portion 1-5% by weight of sugar, which prevents the cement from setting and increases Ca(OH)2 solubility. This has been done and it was found that with about 50 grams of Portland cement and 3.7 grams of sugar, CO2 could be removed for 30 days with a carbon negative result, though again the amounts removed are small. The aquarium can be a decorative solution requiring a level of maintenance similar to a fish aquarium, though in this case fish cannot be added as the solutions used have too high a pH.

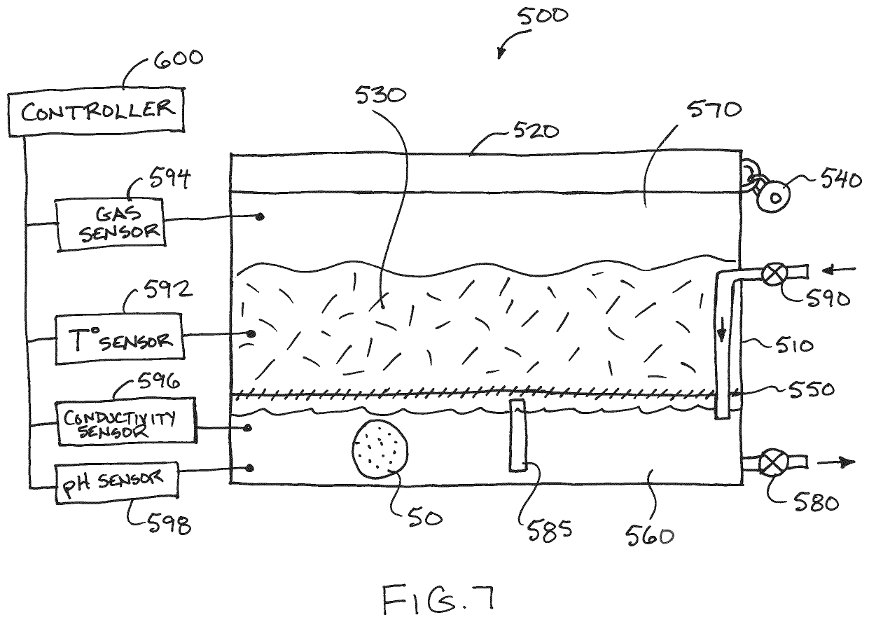

According to another aspect of the present invention, there is provided a system 500 for capturing carbon dioxide released into the air from a biomass material according to FIG. 7.

To put the CO2 problem into context in terms of natural solutions, it is noted that: (i) the average person breathes out about 1 kg of CO2 per day, (ii) it takes about 3500 prayer plants (one of the most CO2 absorbing indoor plants) to take up the CO2 output of one person; (iii) it takes about 15 mature trees to take up the CO2 output of one person; and (iv) it takes about ½ of the grass from a normal ¼ acre suburban yard to take up the CO2 output of one person.

Houseplants essentially do next to nothing compared to trees, this is because they don't grow quickly enough. As a rough rule of thumb, plants, trees and grass can be thought of as being made up by 50% water and 50% CO₂ by weight. This obviously isn't quite true as there is also a small component of nitrogen, and other trace components, however water and CO2 are the main components of growth. Mature trees put on more weight per day than smaller trees and much more than house plants, but still, a significant number are needed to cope with the CO₂ expired by a single person.

In contrast grass grows very quickly and is a major means of CO2 absorption, however there are problems with grass. First of all, grass dies quickly and much of the stored CO2 is therefore very quickly returned to the atmosphere. We did measurements with 1.5 kg of freshly mowed grass clippings placing them into a sealed 72 Litre container with a CO2 monitor (within 5 minutes) and found that within a further 13 minutes CO2 began to be emitted by the grass clippings. The meter was saturated at its highest reading of 5000 ppm after about an hour. Normal outside levels are approximately 400 ppm. These measurements are shown in FIG. 4, below, where it can also be seen that the rate of emission began accelerating so that 23 hours later (the container was reopened to let some of the CO2 out so that the meter was back in scale) it had increased to 300 ppm per minute of CO2 being emitted, equivalent to 57 grams a day if that emission rate were maintained.

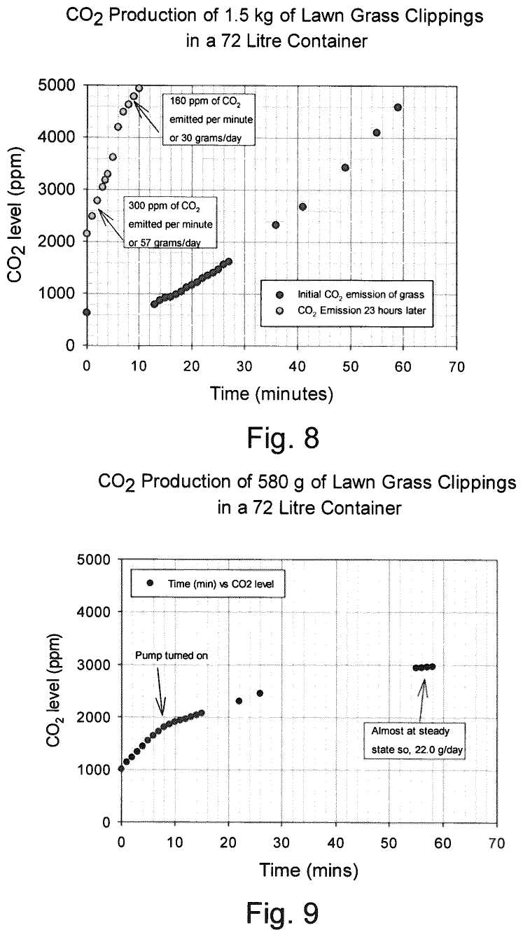

Another issue with grass is that it's maintenance in first world locations uses a lot of CO2. CO2 is produced during the production of fertilizers and in the treatment of tap water, it is also produced by gasoline combustion when lawns are mown. Because of these issues lawns often end up being net CO2 emitters rather than CO2 sinks. These problems can be overcome by using natural fertilizers from local sources, compost for instance, or weak carbonic acid and/or ammonium bicarbonate/ammonium carbonate (as described herein); electric mowers rather than gasoline mowers; and by the use of rainwater rather than treated tap water. However, all of this being done, the CO2 storage value of grass remains marginal, especially with continued mowing, as much of the stored CO2 is returned to the air very quickly on the death of the grass. This is confirmed in FIG. 8.

What we propose is to harvest CO2 from grass clippings. When placed in an enclosed space grass clippings quickly decompose releasing CO2 and raising the CO2 content of the space. For the techniques we've examined, the removal of CO2 from air increases proportionally to the amount of CO2 in the air so that concentrating the CO2 increases removal efficiency. We had initially thought to use cement and concrete waste products via reactions similar to equation [9] with the grass clippings. The inflection point for the CO2 emission for the 23 hour data of FIG. 4, is where our air pump was turned on to cycle the air in the 72 Litre container through a smaller ABS container with 301 grams of crushed white Portland cement in 1.5 Litres of water with 13.9 grams of sugar. When the air was pumped through the solution the CO2 emitted into the 72 Litre container dropped from 300 ppm/minute to 160 ppm/minute, so that the cement mixture was absorbing 140 ppm/minute, or 27 grams/day of CO2. This was about 40% of the CO2 absorption of a mature tree and can be compared to the 3.5 grams/day at 400 ppm for a similar experiment described in section 5, above. As the CO2 level in the 72 Litre climbed further, the extraction of CO2 by the waste cement would also increase, until the two equilibrated at a higher value than we were able to measure with our current CO2 monitor.

In another experiment using only 580 grams of the original grass clippings, the cement waste was able to absorb the CO2 at almost a steady state with emission by the grass, as shown in FIG. 9. The rate of CO2 increase with the pump off had been 100 ppm/minute, so 22 grams/minute were being removed by the cement mixture. With the 1.5 kg of grass and given that the emission is proportional with grass clipping weight, the full 57 grams/minute would have been removed at around 7750 ppm of CO2, this was almost the same removal rate as a fully mature tree.

The advantage of concentrating the CO2 from grass clippings in a closed container is therefore shown since it can make the removal process many times more efficient than for CO2 extraction at 400 ppm. The collection can be scaled to that of a local lawn, which collects the equivalent of the CO2 expired by 0.5 to two people (dependent on grass type, and local growth rates), though the handling of the cement waste becomes an issue requiring some logistics. Removal with waste cement becomes a very efficient process with the CO₂ at higher values, however, experimentation provided another possibility.

Another experiment was carried out with 746 grams of freshly cut grass placed in the 72 Litre container along with a beaker with 1 Litre of tap water at with pH of 8.8. A sealed ABS canister had a further 1.5 Liters of water in it and air was circulated from the 72 Litre container to the canister via an aquarium pump through an aeration stone at the bottom of the canister. The air was then returned to the 72 Litre container. So there were two water experiments, one that just absorbed CO2 by surface absorption (which might take a couple of days) and another with forced air bubbling through the water. The CO2 level of the 72 Litre container was >5000 ppm within about an hour of the start of the experiment.

Henry's law of chemistry states that the amount of dissolved gas in a liquid is proportional to its partial pressure above the fluid. The proportionality is provided for each gas/liquid combination by Henry's constant the dimensionless version of the law is given by the equation

Hₛ^{cc}=c_{aq}/c_{gas}

Where Hₛ^{cc} is Henry's constant for dimensionless solubility, c_{ag} is the aqueous phase concentration of the gas, and c_{gas} is the gas phase concentration. For CO2 in water this Henry constant is 0.83 at room temperature, so when there is 400 ppm of CO2 in the atmosphere, water at equilibrium will have a value of 332 ppm of CO2. For the sealed container with grass cuttings with its higher partial pressure of CO2 in the container, there will be a proportionally higher concentration of CO2 in the water. This should result in the water becoming quite acidic from carbonic acid, as per equation 4, above. However, nature can be far more complex than expected. Although we saw an initial decrease in pH down to 5.7 after 5 days of exposure caused by the formation of carbonic acid in the water, this pH is similar to rainwater. Given the higher amount of CO2 present in the container (>5000 ppm) the water should have been far more acidic than rain water. Also, the pH of the water in the ABS canister was even higher at a value of 6.5, it should have been lower than the beaker as it should have absorbed more CO2 given the large surface provided by forced bubbling. A second process seemed to be occurring that was limiting the acidity of the water.

The canister experiment was stopped and a fresh Litre of tap water was put in the beaker. Its pH was 7.6 at the beginning of the experiment and its pH was checked more regularly. After about 4.5 hours the pH had dropped to 6.7; after about 23 hours it had dropped to 6.3; after 40 hours it had dropped to 5.9, however after a further 24 days the pH had risen to 8.4, which was alkaline. The CO2 level in the container was still >5000 ppm, however there was a definite ammoniacal smell from the grass. Microbes in the grass had started to break down the nitrogen and create nitrous oxide. Typically, when there is more nitrogen in the grass than the microbes can digest due to the very high nitrogen content in grass, ammonia is also formed. Ammonia in water becomes ammonium hydroxide as per equations [6] and [7]. Combining with carbonic acid, the ammonium hydroxide can create ammonium bicarbonate, and at higher pH ammonium carbonate. Ammonium bicarbonate can act as a buffer. Grass clippings are relatively rich in nitrogen compared to other plants, carbon to nitrogen ratios can be 15-25:1.

For a third experiment the water in the beaker was changed to fresh tap water with pH 7.5. After 24 hours the pH had gone up to 8.3. This shows that as the grass breaks down ammonia evaporating from the grass is being collected in the water and combining with the carbonic acid to form pre-dominantly ammonium bicarbonate, and perhaps some ammonium carbonate. This is advantageous, if the grass clippings had only emitted CO2 then for 1.5 kg of grass clipping (eventually emitting about 0.75 kg of CO2) if the level of CO2 in the 72 Litre container was 8000 ppm about 46 Litres of water would be needed to absorb the carbonic acid at that gas concentration. However, ammonium bicarbonate is soluble in water to 216 grams/Litre at 20° C., so only about 3.5 Litres of water is needed to absorb the same amount of CO2. Excess water can be used to dilute the solution.

The lower amount of nitrogen in grass compared to carbon means that decomposition of the carbon will be dominant for much of the decomposition cycle. Nitrogen decomposition may be active/dominant for a shorter period. Both decomposition processes are driven by microbes present in the grass clippings, though microbe strains could be added to promote faster decomposition.

This then becomes a method for storing CO2 which could have a valid economic reason for adoption. The CO2 is harvested from grass clippings in a compost system to form carbonic acid, which can act as a carbon fertilizer, and ammonium bicarbonate, which can be a nitrogen fertilizer as well as a carbon fertilizer. This can be done locally at the level of a household, or on a larger scale for agriculture or for municipalities.

A simple embodiment uses a sealed container, which might be referred to as a CO2 grass clipping harvester. Water, preferably untreated rain water (to limit CO2 inputs, since CO2 is produced in the treatment of tap water) is temporarily stored in the base of the container. Above the water is a screen which allows transmission of gases and vapours from the decomposing grass clippings (though other compost might be added). The grass clippings sit on the screen and can be added to, or removed from, the container by taking off a locked top. Because the container is sealed and quite high CO2 levels might be achieved, the container is an asphyxiation hazard for children and must be kept locked while not open to the air. The unit would be of sufficient volume to allow a few weeks of lawn clippings to be stored. The conductivity of the water can be monitored to determine the loading of potential fertilizer solutes in the water, the pH can also be monitored, low pH indicates that the carbon cycle is dominant, high pH indicates that the nitrogen cycle is active. The chamber CO2 level could also be monitored and the NH3 level could also be monitored. A water inlet and outlet could allow water to be input and removed without opening the chamber to the air. Alternately the top of the container can be removed and water can be added by spraying the grass clippings and allowing the water to seep to the bottom of the container. Occasionally opening the container to allow oxygen in may be useful as the microbes that decompose the grass require oxygen to produce CO2. A small portion of CO2 will be lost during opening but the grass is emitting CO2 continuously over many days (and perhaps weeks) so that the levels will quickly build up again when the container is resealed. Having the container big enough to contain a reserve of oxygen is useful.

The water removed from the chamber could be used to directly fertilize plants, lawns, and other vegetation, allowing local production of a fertilizer rather than reliance on commercial fertilizers. Water in the chamber may take several days to absorb adequate carbonic acid/ammonium bicarbonate and related vapours and gases, so a large 50 Litre water storage capacity could be envisaged. Waste clippings that have given up much of their gases and vapours can be removed from the container for further compositing through normal means.

In another embodiment, mentioned above, cement or concrete waste can be used in the water reservoir, which would raise the pH of the water and ensure more thorough removal of CO2 from the container. In this case much of the CO2 would be sequestered more permanently as calcium carbonate and the water may or may not be suitable for fertilizer. This embodiment might be of greater interest for municipalities who are treating their waste grass clippings, rather than households as the logistics become easier for a single location with large scale cement handling facilities.

In another embodiment of the system, air might be forced to circulate through the water using aeration devices so that the uptake of CO2, ammonia and other gases and vapours from the decomposition of the grass is quicker.

The decomposition of grass is known to be caused by microbes. In another embodiment it might be possible to add particular microbial species to enhance the decomposition of the grass clippings.

Turning now more particularly to the embodiment of FIG. 7, the system 500 is further arranged to increase the concentration of carbon dioxide within the air that is exposed to the water for assisting the absorption of carbon dioxide into the water. According to the embodiment of FIG. 7, there is provided a vessel 510 defining an enclosed interior space suitable for containing water and air therein such that the air and other gases cannot escape from the enclosed space. The enclosed space according to the embodiment of FIG. 7 is defined within a single vessel that is enclosed by a bottom panel forming a floor of the vessel and side walls which extend upwardly about a full perimeter of the bottom panel towards an open top that is selectively enclosed by a suitable lid 520. More particularly, the lid is operable between an open position in which the top side of the vessel 510 is fully open for loading biomass material 530 into the enclosed spaced within vessel therethrough and a closed position in which the top of the vessel is fully enclosed by the lid. A locking mechanism 540 is operatively connected between the lid and the vessel in the closed position for preventing unauthorized persons from opening the lid. The lid may be provided with a suitable gasket extending about the perimeter of the open top of the vessel to form an airtight seal between the lid 520 and the vessel 510 in the closed position of the lid.

The vessel 510 includes a partition member 550 mounted therein which divides the interior chamber of the vessel into a first chamber 560 and a second chamber 570 on opposing sides of the partition. In the illustrated embodiment of FIG. 7, the partition member 550 is a screen member spanning horizontally across the full area of the vessel at a location spaced above the bottom of the vessel to define the first chamber below the partition and the second chamber above the partition. The screen forming the partition is gas permeable to permit air to readily pass therethrough between the first and second chambers. In alternative arrangements, the partition may be vertically mounted to locate the first and second chambers laterally beside one another while maintaining an open path of communication of gas between the first and second chambers near the top end of the vessel while the majority of the partition below the communication path is waterproof for containing a volume of water in one of the chambers.

The partition 550 includes sufficient structure to support the weight of the biomass material 530 thereon which is placed in the second is chamber 570 above the partition when the lid is opened. The biomass material in the preferred embodiment comprises grass clippings from a lawn; however, other types of biomass may be used in a similar manner including various yard and garden waste, crop residue, manure and the like.

An outlet valve 580 communicates through the boundary wall of the vessel 510 adjacent the bottom of the vessel so that water contained in the first chamber 560 can be selectively discharged from the vessel when the outlet valve is opened. Normally the outlet valve remains closed as the biomass material decomposes to emit carbon dioxide within the enclosed chamber of the vessel so that the increase in carbon dioxide concentration facilitates more absorption of carbon dioxide into the water contained in the first chamber. When the water has been suitably enriched by absorbed carbon from carbon dioxide in the air, the water can be discharged through the outlet valve 580 onto a suitable plant growing medium such as soil in a garden bed or any other medium suitable for growing various plants thereon. The air contained within the interior chamber of the vessel 510 remains sealed within the vessel as the outlet valve is opened and closed provided that the water level remains above the communication of the outlet valve 580 with the interior of the chamber.

An inlet valve 590 communicates through the boundary wall of the vessel at a location spaced above the outlet valve 580 and is also operable between open and closed positions. The inlet valve may communicate with a tube within the interior of the vessel that extends downwardly from the inlet valve to an inner end of the tube which is an open communication with the first chamber within the vessel at a location spaced below the partition 550. Adding water through the inlet valve while the lid remains closed generally keeps the air sealed within the vessel to prevent escape of the carbon dioxide enriched air while adding water to the vessel. Additional water can be introduced into the vessel through the inlet valve 590 to maintain water level within the first chamber of the vessel within a desired range. A sight glass 585 may be mounted within the boundary wall of the vessel 510 in alignment with the first chamber 560 so that the level of water within the interior of the vessel can be visually monitored externally of the vessel for determining how much water should be introduced into the vessel and when the water should be added without the need to open the lid of the vessel which would otherwise allow the concentrated carbon dioxide to escape.

Similarly to previous embodiment, a filter bag 50 or other suitable envelope containing a source of calcium hydroxide and/or other hydroxides is submerged within the water in the first chamber of the vessel.

To monitor operation of the system 500, a series of sensors may be provided as described in the following. A temperature sensor 592 is mounted in communication with the interior of the second chamber receiving the biomass material therein for measuring a temperature of the biomass material as it decomposes for generating alarm if the temperature of the decomposing biomass becomes elevated to a dangerous level. A gas concentration sensor 594 is also provided in communication with the interior of the vessel 510 for measuring a concentration level of the carbon dioxide within the air contained within the vessel 510 and/or a concentration NH3 to monitor the process. An electrical conductivity sensor 596 is also provided in communication with the interior of the first chamber receiving water therein which is indicative of the concentration of various compounds dissolved in the water to determine the loading of potential fertilizer solutes in the water. The conductivity sensor 596 may also measure electrical conductivity at different elevations for use as a level monitor to determine if the level of water meets or exceeds the level of the one or more conductivity sensors within the vessel to determine if the water level reaches respective upper and lower limits of the vessel. A pH sensor 598 also communicates with the first chamber to measure the pH value of the water in the vessel.

Each of the sensors may communicate with a suitable controller 600 in the form of a computer having (i) a memory storing programming instructions and storing various thresholds relating to the values measured by the sensors and (ii) a processor for executing the programming instructions to perform the functions of the controller. More particularly the controller may be arranged to monitor the measured temperature value, the measured gas concentration values, the pH value, and the measured hydraulic conductivity value from the respective sensors to compare the measured values to corresponding upper and/or lower limits stored on the controller. If any of the measured values meet or exceed a corresponding threshold stored on the controller, the controller may be further arranged to activate an alarm or generate an alert communicated over a suitable network to a user computer device such as a smart phone. For example, when the measured conductivity value reaches a desired threshold range, that is a conductivity value that is above a lower threshold value, the user may be notified that the water can be used as fertilizer and should be discharged and replaced with fresh water. Alternatively, notification may be generated in response to other thresholds being met that are indicative of a corrective action which should be taken.

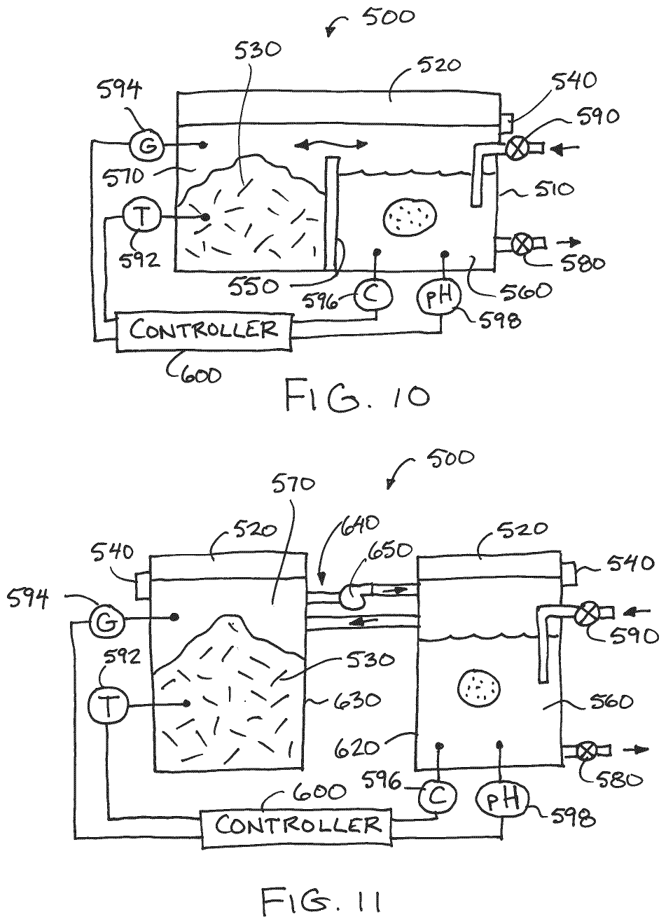

Turning now to FIG. 10, a variant of the capturing apparatus 500 of FIG. 7 will now be described. In this instance, the system 500 again includes a first chamber 560 receiving the water therein and a second chamber 570 receiving the decomposing biomass therein in which the chambers are located within a common vessel 510 while being separated from one another by a partition 550; however, the partition in this instance is upright or vertical in orientation such that the first and second chambers are laterally beside one another within the common vessel 510. The partition 550 is joined to the bottom wall and side walls of the vessel such that at least a lower portion of the partition is impervious to water so that a prescribed volume of water can be contained within the first chamber. In the illustrated embodiment, the partition remains open between the first and second chambers adjacent the top end of the vessel so that air and gas can freely communicate between the first and second chambers through the opening above the partition 550. The first and second chambers again collectively define a fully enclosed space within the vessel 510 from which the gas and the air cannot escape when the lid 520 is closed. The apparatus 500 in this instance otherwise functions substantially identically to the previous embodiment with regard to configuration of the inlet valve 580 and the outlet valve 590 in communication with the first chamber 560. A filter bag 50 containing calcium hydroxide may again be provided within the first chamber for enriching the water with hydroxides. Sensors 592, 594, 596, and 598 communicate with the corresponding chambers and the controller 600 similarly to the previous embodiment.

Turning now to FIG. 11, in this instance the capturing apparatus 500 locates the first chamber 560 in a first vessel 620 and locates the second chamber 570 in a second vessel 630 that is separate and detached from the first vessel 620. Each vessel has a lid 520 with an associated lock 540 to provide access only to authorized persons while enabling authorized persons to load the biomass into the second chamber of the second vessel when the lid is opened. The lid 520 on the first vessel provides similar access the interior of the first chamber within the first vessel. The inlet valve 580 and the outlet valve 590 communicate with the first chamber 560 in the usual manner by being operatively connected to the first vessel 620. The conductivity sensor 596 and the pH sensor 598 likewise communicate with the water in the interior of the first chamber 560 of the first vessel 620. The gas sensor 594 and the temperature sensor 592 communicate with the interior of the second chamber within the second vessel 630; however, all sensors communicate with the controller 600 in the usual manner.

Piping in the form of one or more ducts 640 communicate between (i) a headspace above a prescribed level of liquid within the first chamber adjacent the top end of the first chamber 560 within the first vessel, and (ii) an interior of the second chamber 570 within the second vessel 630. Optionally, a suitable air pump 650 such as a fan or blower can be used to drive flow of gas and air between the chambers in one direction while a separate return duct allows a return flow of gas and air between the chambers in the other direction to drive mixing and recirculation of gas between the chambers. The ducts 640 communicating between the first chamber 560 and the second chamber 570 define the only openings in the chambers when the lids 520 are closed such that the first and second chambers 560 and 570 within the first and second vessels 620 and 630 collectively define a common enclosed space through which gas and air can be transmitted while preventing the escape of gas or air from the enclosed space while the lids 520 remain closed.

Since various modifications can be made in the invention as herein above described, and many apparently widely different embodiments of same made, it is intended that all matter contained in the accompanying specification shall be interpreted as illustrative only and not in a limiting sense.

1. A capturing apparatus for capturing carbon dioxide and/or ammonia released from a decomposing biomass material, the apparatus comprising:
a first chamber arranged to contain water therein; and
a second chamber arranged to receive the biomass therein;
the first chamber and the second chamber being in open communication with one another such that gas and air can be transmitted between the first chamber and the second chamber; and
the first chamber and the second chamber collectively defining an enclosed space from which the gas and the air cannot escape.

2. The apparatus according to claim 1 further comprising an outlet valve in communication with a bottom of the first chamber so as to be arranged to controllably discharge the water from the first chamber therethrough while the gas and the air remains trapped within the enclosed space.

3. The apparatus according to claim 2 further comprising an inlet valve in communication with the first chamber of the vessel at a location spaced above the outlet valve so as to be arranged to controllably introduce the water into the first chamber therethrough while the air remains trapped within the enclosed space.

4. The apparatus according to claim 1 wherein the first chamber and the second chamber are located within a common vessel and are separated from one another by a partition.

5. The apparatus according to claim 4 wherein the partition comprises a screened member supported at a location spaced above a bottom of the vessel to define the first chamber below the partition and the second chamber above the partition, the partition being arranged to support the biomass material thereon while permitting the air to communicate through the screened member between the first and second chambers.

6. The apparatus according to claim 1 wherein the first chamber and the second chamber are located within a first vessel and a second vessel respectively, and wherein the apparatus includes piping in communication between the first vessel and the second vessel through which the gas and the air can be transmitted between the first chamber and the second chamber.

7. The apparatus according to claim 1 wherein at least the second chamber includes (i) a lid operable between open and closed positions relative to an opening in the second chamber through which the biomass material can be loaded into the second chamber, and (ii) a lock arranged to selectively secure the lid in the closed position to prevent opening of the lid by unauthorized persons.

8. The apparatus according to claim 1 in combination with the water in the first chamber, the water being enriched with hydroxides.

9. The apparatus according to claim 1 further comprising an air pump arranged to recirculate the air within the enclosed space between the first and second chambers.

10. The apparatus according to claim 1 further comprising a temperature sensor arranged to measure a temperature value representative of a temperature of the biomass material in the second chamber of the enclosed space.

11. The apparatus according to claim 1 further comprising a carbon dioxide sensor arranged to measure a carbon dioxide value representative of a carbon dioxide concentration level within the enclosed space.

12. The apparatus according to claim 1 further comprising a water conductivity sensor arranged to measure a conductivity value representative of an electrical conductivity of the water in the first chamber of the enclosed space.

13. The apparatus according to claim 1 further comprising a controller arranged to (i) monitor a value measure by a sensor, (ii) compare the monitored value to a threshold range, and (iii) generate an alert responsive to the monitored value falling within the threshold range.

14. A method of capturing carbon dioxide and/or ammonia from biomass material, the method comprising:
providing a capturing apparatus comprising a first chamber and a second chamber in open communication with one another such that air can be transmitted between the first chamber and the second chamber, wherein the first chamber and the second chamber collectively define an enclosed space from which said air cannot escape;
placing the biomass material in the second chamber and allowing the biomass material to decompose in the second chamber whereby said air within the enclosed space is enriched with carbon dioxide and ammonia;
providing a source of water enriched with hydroxides in the first chamber such that carbon dioxide in solution in the water is below equilibrium with carbon dioxide in the air within the enclosed space and the water absorbs some of the carbon dioxide in the air.

15. The method according to claim 14 including, after the water absorbs some of the carbon dioxide in the air, discharging the water from the enclosed vessel as fertilizer onto a plant growing medium.

16. The method according to claim 14 wherein the biomass material includes grass clippings from a lawn.

17. The method according to claim 14 wherein the biomass material includes garden waste.

18. The method according to claim 14 wherein the biomass material includes crop residue.

19. The method according to claim 14 wherein the biomass material includes manure.

20. The method according to claim 14 further comprising adding microbes to the biomass material to enhance decomposition of the biomass.
